(19) United States
(12) Patent Application Publication
(10) Pub. No.: US 2008/0196832 A1
(43) Pub. Date: Aug. 21, 2008

(54) Sheet adhering apparatus and sheet adhering method

(75) Inventors: Reki Nakamura, Sagamihara city (JP); Mikio Ishibashi, Yokohama city (JP); Kazuhisa Sudo, Kawasaki city (JP); Nobuyuki Koinuma, Yokohama city (JP); Kazuhiko Yuki, Kawasaki city (JP); Yukiko Iwasaki, Yokohama city (JP); Megumi Ohtoshi, Yokohama city (JP); Takashi Sakamaki, Ebina city (JP); Ryuji Yoshida, Yokohama city (JP)

Correspondence Address: HARNESS, DICKEY & PIERCE, P.L.C., P.O. BOX 8910, RESTON, VA, 20195, US

(73) Assignee: Ricoh Company, Ltd.

(21) Appl. No.: 12/010,590

(22) Filed: Jan. 28, 2008

(30) Foreign Application Priority Data
Feb. 15, 2007 (JP) 2007-035533
Sep. 14, 2007 (JP) 2007-239605

(51) Int. Cl. B32B 37/00

(52) U.S. Cl. 156/324; 156/538

(57) ABSTRACT

A sheet adhering apparatus includes an adhering device to convey a first sheet at a first conveyance speed and a second sheet at a second conveyance speed different from the first conveyance speed. The adhering device causes the second sheet to obliquely contact and adhere to the first sheet at a given adhering angle.

### PRIORITY STATEMENT

The present patent application claims priority from Japanese Patent Application Nos. 2007-035533 filed on Feb. 15, 2007 and 2007-239605 filed on Sep. 14, 2007 in the Japan Patent Office, the entire contents of which are hereby incorporated herein by reference.

### BACKGROUND OF THE INVENTION

1. Field of the Invention

Example embodiments generally relate to a sheet adhering apparatus and a sheet adhering method, for example, for adhering sheets to each other.

2. Description of the Related Art

A photographic image is formed by various methods. In one example method, an image recording sheet bearing a photographic image is formed by adhering sheets to each other to sandwich the image. For example, a transparent sheet bearing a toner image formed by an image forming apparatus in an electrophotographic method is adhered to a non-transparent sheet (e.g., a white sheet) to form an image recording sheet in which the toner image is sandwiched between the transparent sheet and the non-transparent sheet. An adhesive (e.g., an aerosol adhesive) is sprayed on one side of the transparent sheet on which the toner image is formed. The non-transparent sheet is adhered to the sprayed side of the transparent sheet to form the image recording sheet.

The image recording sheet may effectively provide a photographic image having an increased gloss. However, whether the image recording sheet is formed by adhering the transparent sheet and the non-transparent sheet manually or mechanically, air bubbles may be generated between the transparent sheet and the non-transparent sheet or the image recording sheet may be curled or wrinkled. For example, when the non-transparent sheet is adhered to the transparent sheet, small and/or large air bubbles may be generated between the transparent sheet and the non-transparent sheet due to a rough adhering surface, vibration, and/or an improper adhering angle of the transparent sheet and the non-transparent sheet. Further, when the transparent sheet and/or the non-transparent sheet are curled before or after the non-transparent sheet starts adhering to the transparent sheet, the image recording sheet formed by adhering the non-transparent sheet to the transparent sheet may also be curled or wrinkled.

Even a small number of small air bubbles generated between the transparent sheet and the non-transparent sheet are capable of scattering light, which may cause the image formed in the image recording sheet to look like it is covered with fine dust and resulting in a faulty image.

### SUMMARY

At least one embodiment may provide a sheet adhering apparatus that includes an adhering device to convey a first sheet at a first conveyance speed and a second sheet at a second conveyance speed different from the first conveyance speed. The adhering device causes the second sheet to obliquely contact and adhere to the first sheet at a given adhering angle.

At least one embodiment may provide a sheet adhering method that includes conveying a first sheet at a first conveyance speed in a first sheet conveyance direction, conveying a second sheet at a second conveyance speed in a direction oblique to the first sheet conveyance direction different from the first conveyance speed, and contacting the second sheet against the first sheet at a given adhering angle.

Additional features and advantages of example embodiments will be more fully apparent from the following detailed description, the accompanying drawings, and the associated claims.

### BRIEF DESCRIPTION OF THE DRAWINGS

A more complete appreciation of example embodiments and the many attendant advantages thereof will be readily obtained as the same becomes better understood by reference to the following detailed description when considered in connection with the accompanying drawings, wherein:

FIG. 1 is a sectional view of an image forming apparatus and a sheet adhering apparatus according to an example embodiment;

FIG. 2 is an enlarged sectional view (according to an example embodiment) of the sheet adhering apparatus shown in FIG. 1;

FIG. 3 is a sectional view (according to an example embodiment) of a transparent sheet and a non-transparent sheet before being nipped by a pressing roller pair included in the sheet adhering apparatus shown in FIG. 2;

FIG. 4 is a sectional view (according to an example embodiment) of the transparent sheet and the non-transparent sheet while being nipped by the pressing roller pair shown in FIG. 3;

FIG. 5 is another sectional view (according to an example embodiment) of the transparent sheet and the non-transparent sheet while being nipped by the pressing roller pair shown in FIG. 3;

FIG. 6 is a sectional view (according to an example embodiment) of the transparent sheet and the non-transparent sheet shown in FIG. 3 sandwiching air bubbles;

FIG. 7 is a sectional view (according to an example embodiment) of the transparent sheet and the non-transparent sheet shown in FIG. 6 for explaining light diffused by the air bubbles;

FIG. 8A is a plane view (according to an example embodiment) of an example of the transparent sheet shown in FIG. 3;

FIG. 8B is a plane view (according to an example embodiment) of another example of the transparent sheet shown in FIG. 3;

FIG. 8C is a plane view (according to an example embodiment) of yet another example of the transparent sheet shown in FIG. 3;

FIG. 8D is a plane view (according to an example embodiment) of yet another example of the transparent sheet shown in FIG. 3;

FIG. 9 is a sectional view of a transparent sheet and a non-transparent sheet before being nipped by a pressing roller pair included in a sheet adhering apparatus according to another example embodiment;

FIG. 10 is a sectional view (according to an example embodiment) of the transparent sheet and the non-transparent sheet while being nipped by the pressing roller pair shown in FIG. 9;

FIG. 11 is a sectional view (according to an example embodiment) of the transparent sheet and the non-transparent sheet shown in FIG. 9 adhered to each other; and

FIG. 12 is a perspective view of a non-transparent sheet sliding along a transparent sheet in a sheet adhering apparatus according to yet another example embodiment.

The accompanying drawings are intended to depict example embodiments and should not be interpreted to limit the scope thereof. The accompanying drawings are not to be considered as drawn to scale unless explicitly noted.

### DETAILED DESCRIPTION OF EXAMPLE EMBODIMENTS

It will be understood that if an element or layer is referred to as being “on”, “against”, “connected to”, or “coupled to” another element or layer, then it can be directly on, against, connected or coupled to the other element or layer, or intervening elements or layers may be present. In contrast, if an element is referred to as being “directly on”, “directly connected to”, or “directly coupled to” another element or layer, then there are no intervening elements or layers present. Like numbers refer to like elements throughout. As used herein, the term “and/or” includes any and all combinations of one or more of the associated listed items.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

The terminology used herein is for the purpose of describing particular embodiments only and is not intended to be limiting of the present invention. As used herein, the singular forms “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments illustrated in the drawings, specific terminology is employed for the sake of clarity. However, the disclosure of this specification is not intended to be limited to the specific terminology so selected and it is to be understood that each specific element includes all technical equivalents that operate in a similar manner.

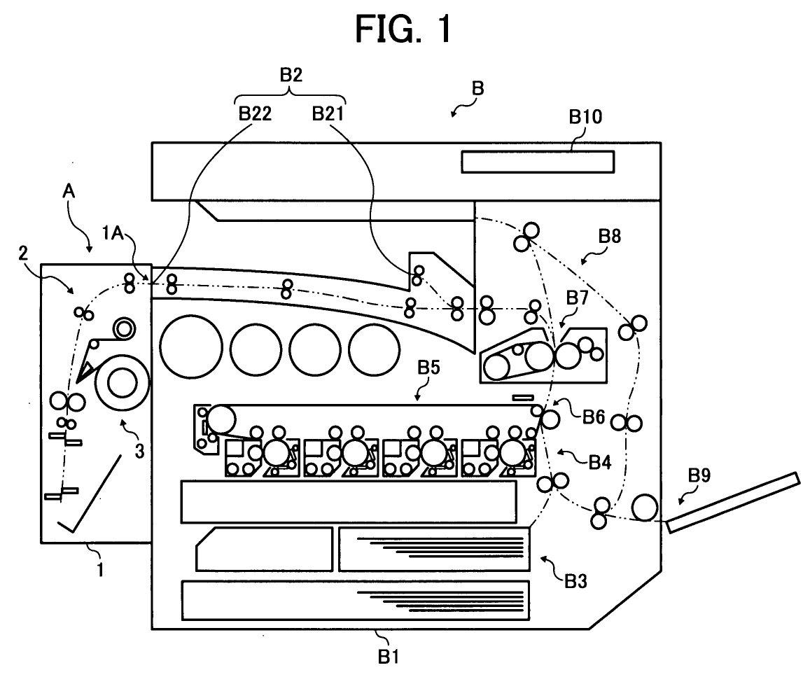

Referring now to the drawings, wherein like reference numerals designate identical or corresponding parts throughout the several views, particularly to FIG. 1, an image forming apparatus B and a sheet adhering apparatus A according to an example embodiment are explained.

As illustrated in FIG. 1, the image forming apparatus B includes a case B1, a paper tray B3, a bypass tray B9, a recording sheet conveyance path B4, an image forming device B5, a transfer device B6, a fixing device B7, a reversing device B8, an output device B2, and/or a controller B10. The output device B2 includes an internal output portion B21 and/or an external output portion B22. The sheet adhering apparatus A includes a case 1, a conveyer 2, an unreeling device 3, and/or a sheet reception opening 1A.

The image forming apparatus B may be a copier, a facsimile machine, a printer, a multifunction printer having two or more of copying, printing, scanning, and facsimile functions, or the like. According to this non-limiting example embodiment, the image forming apparatus B functions as a color copier for forming a color image on a recording medium (e.g., a recording sheet) by an electrophotographic method.

The case B1 forms an exterior appearance of the image forming apparatus B. Each of the paper tray B3 and the bypass tray B9 loads recording sheets and feeds the recording sheets one by one toward the recording sheet conveyance path B4. The recording sheet conveyance path B4 connects the paper tray B3 and the bypass tray B9 to the output device B2, and conveys a recording sheet fed from the paper tray B3 or the bypass tray B9 to the output device B2. The image forming device B5 is provided at a position between the paper tray B3 and the output device B2, and forms a color toner image according to image data by using toner (e.g., polymerized toner particles having a small particle size). The transfer device B6 transfers the color toner image formed by the image forming device B5 onto the recording sheet conveyed on the recording sheet conveyance path B4. The fixing device B7 is provided at a position between the transfer device B6 and the output device B2, and applies heat and pressure to the recording sheet bearing the color toner image to fix the color toner image on the recording sheet. The fixing device B7 feeds the recording sheet bearing the fixed color toner image toward the output device B2 or the reversing device B8. The reversing device B8 is connected to upstream and downstream positions on the recording sheet conveyance path B4 provided upstream from the transfer device B6 and downstream from the fixing device B7, respectively, in a sheet conveyance direction. The reversing device B8 receives the recording sheet sent from the fixing device B7 at the downstream position, and reverses and conveys the recording sheet to the upstream position.

The output device B2 receives the recording sheet bearing the fixed color toner image sent from the fixing device B7. The internal output portion B21 outputs the recording sheet onto an output tray (not shown) provided in the image forming apparatus B. The external output portion B22 is connected to the sheet adhering apparatus A, and outputs the recording sheet to the sheet adhering apparatus A through an opening provided in the case B1. The sheet adhering apparatus A is connected to the image forming apparatus B to receive the recording sheet output from the external output portion B22.

The controller B10 includes a control panel (not shown) and controls operations of the image forming apparatus B. The controller B10 also controls operations of the sheet adhering apparatus A via an interface.

The image forming apparatus B having the above-described structure forms an image on a recording sheet by known electrophotographic processes. For example, the image forming apparatus B transfers a toner image formed with small polymerized toner particles onto a recording sheet, fixes the toner image on the recording sheet, and outputs the recording sheet bearing the fixed toner image from the internal output portion B21 or the external output portion B22. When the image forming apparatus B forms an image on a recording sheet together with the sheet adhering apparatus A, the image forming apparatus B uses a transparent sheet S1, serving as a first sheet, as the recording sheet on which the image is formed, and a mirror image P of the image is formed on the transparent sheet S1.

In the sheet adhering apparatus A, the case 1 forms an exterior appearance of the sheet adhering apparatus A, and has a box-like shape in which the conveyer 2, the unreeling device 3, and/or other elements are disposed. The sheet reception opening 1A, an electric connector (not shown), and a mechanical connector (not shown) are provided in a side cover of an upper portion of the case 1. The sheet adhering apparatus A is attachable to and detachable from the image forming apparatus B. The sheet reception opening 1A of the sheet adhering apparatus A forms a continuous hole together with the external output portion B22 of the image forming apparatus B. The conveyer 2 and the unreeling device 3 form an adhering device.

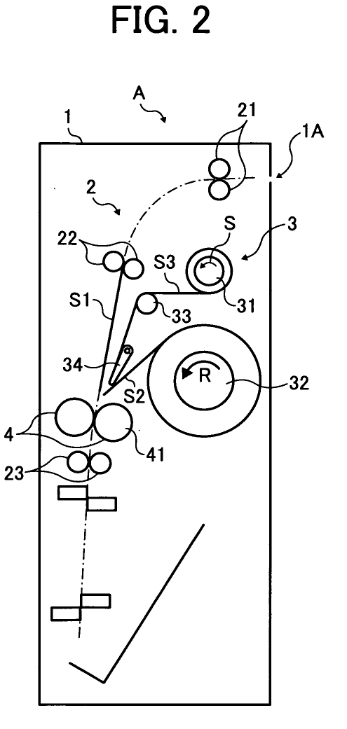

FIG. 2 is a sectional view of the sheet adhering apparatus A. As illustrated in FIG. 2, the sheet adhering apparatus A further includes a pressing roller pair 4. The pressing roller pair 4 includes a pressing roller 41. The conveyer 2 includes a first roller pair 21, a second roller pair 22, and/or a third roller pair 23. The unreeling device 3 includes a reel shaft 31, a support shaft 32, an idle shaft 33, and/or a separation plate 34.

The pressing roller pair 4 serves as a pressing portion. The pressing roller 41 is one roller of the pressing roller pair 4, and is provided closer to the unreeling device 3 than another roller of the pressing roller pair 4. The first roller pair 21 is rotatably provided near the sheet reception opening 1A. The second roller pair 22 is rotatably provided at a lower left of the first roller pair 21. The third roller pair 23 is rotatably provided at a lower left of the second roller pair 22. The first roller pair 21, the second roller pair 22, the third roller pair 23, and a guide wall (not shown) bend and convey downward the transparent sheet S1, that is, the recording sheet bearing the mirror image P and sent from the external output portion B22 of the image forming apparatus B (depicted in FIG. 1) in a substantially horizontal direction toward the sheet reception opening 1A. The controller B10 (depicted in FIG. 1) of the image forming apparatus B may output a control command to control rotation of the first roller pair 21, the second roller pair 22, and the third roller pair 23 of the sheet adhering apparatus A.

The reel shaft 31 is provided under the first roller pair 21 and at a right side of the second roller pair 22. Rotation of the reel shaft 31 may be controlled. The support shaft 32 is rotatably provided under the reel shaft 31 and above the pressing roller pair 4. The idle shaft 33 is rotatably provided between the support shaft 32 and the reel shaft 31 and at a left side of the support shaft 32 and the reel shaft 31. The separation plate 34 has a band plate shape and has thickness gradually decreasing (e.g., narrowing) in a direction perpendicular to a longitudinal direction of the separation plate 34. Specifically, one edge formed along the longitudinal direction of the separation plate 34 has a width narrower than a width of an opposing edge. The separation plate 34 is slanted with respect to a sheet conveyance path connecting the second roller pair 22 to the third roller pair 23. For example, the narrower edge faces the sheet conveyance path at a given angle.

A non-transparent sheet S2 (e.g., a white sheet) has a given length. A peel-stick sheet S3 has a band plate shape. A plurality of non-transparent sheets S2, serving as second sheets, is successively adhered to the peel-stick sheet S3. The plurality of non-transparent sheets S2 and the peel-stick sheet S3 adhered to each other are rolled into a roll in a manner that the non-transparent sheets S2 and the peel-stick sheet S3 form inner and outer circumferential surfaces of the roll, respectively.

The support shaft 32 supports the roll of the non-transparent sheets S2 and the peel-stick sheet S3. When the support shaft 32 rotates counterclockwise (e.g., in a rotating direction R), the non-transparent sheets S2 and the peel-stick sheet S3 adhered to each other are unreeled. The separation plate 34 turns the peel-stick sheet S3 to separate the peel-stick sheet S3 from the non-transparent sheets S2. The separated peel-stick sheet S3 is looped over the idle shaft 33. The reel shaft 31 rotates counterclockwise (e.g., in a rotating direction S) to reel the separated peel-stick sheet S3.

The reel shaft 31 rotates according to a control command output by the controller B10 included in the image forming apparatus B (depicted in FIG. 1). The non-transparent sheets S2 and the peel-stick sheet S3 adhered to each other are unreeled from the roll set on the support shaft 32. The separation plate 34 turns the peel-stick sheet S3, and peels the peel-stick sheet S3 from the non-transparent sheet S2. The non-transparent sheet S2 moves toward the transparent sheet S1 in a direction oblique to a direction in which the conveyer 2 conveys the transparent sheet S1, so that the non-transparent sheet S2 is adhered to the transparent sheet S1. The conveyer 2 and the unreeling device 3 convey the transparent sheet S1 and the non-transparent sheet S2, respectively, in a manner that the non-transparent sheet S2 is slanted with respect to the transparent sheet S1 when the non-transparent sheet S2 contacts the transparent sheet S1. The reel shaft 31 reels and collects the peel-stick sheet S3 separated from the non-transparent sheet S2.

The non-transparent sheet S2 contacts the transparent sheet S1 at a given angle at which the non-transparent sheet S2 is properly adhered to the transparent sheet S1 by applying a suppressed impact. The non-transparent sheet S2 is conveyed at a conveyance speed V2 (e.g., a second conveyance speed) faster than a conveyance speed V1 (e.g., a first conveyance speed) at which the transparent sheet S1 is conveyed.

The narrower edge of the separation plate 34, which contacts the peel-stick sheet S3, has a round foremost point to smoothly turn the peel-stick sheet S3 and to separate the non-transparent sheet S2 from the peel-stick sheet S3 by using a curvature.

The pressing roller pair 4 is rotatably provided at a position slightly downstream from a position at which the non-transparent sheet S2 contacts the transparent sheet S1 on the sheet conveyance path connecting the second roller pair 22 and the third roller pair 23 in the sheet conveyance direction, when the non-transparent sheet S2 and the transparent sheet S1 are conveyed at a common speed (e.g., when the conveyance speed V1 equals to the conveyance speed V2). The pressing roller pair 4 receives the transparent sheet S1 and the non-transparent sheet S2 adhered to each other and applies pressure to the transparent sheet S1 and the non-transparent sheet S2, so as to cause the transparent sheet S1 and the non-transparent sheet S2 to adhere to each other with an increased adhering force.

The following describes operations of the image forming apparatus B (depicted in FIG. 1) and the sheet adhering apparatus A having the above-described structure. The sheet adhering apparatus A is connected to the image forming apparatus B, and is attachable to and detachable from the image forming apparatus B.

As illustrated in FIG. 1, a user selects on the control panel of the image forming apparatus B an output mode for outputting an image recording sheet bearing an image by using the sheet adhering apparatus A. Accordingly, the image forming apparatus B starts forming a mirror image P on a transparent sheet S1. The mirror image P is formed according to image data. For example, a scanning device (not shown) provided on top of the image forming apparatus B scans an original image to create the image data. Alternatively, the mirror image P is formed according to image data sent from an electronic device (e.g., a personal computer or a digital camera). The image forming device B5 forms a toner image (e.g., a mirror image P) with small polymerized toner particles in a known electrophotographic method. The transfer device B6 transfers the toner image onto a transparent sheet S1 supplied from the paper tray B3 or the bypass tray B9. The fixing device B7 fixes the toner image on the transparent sheet S1. The external output portion B22 outputs the transparent sheet S1 bearing the fixed toner image. The transparent sheet S1 bearing the fixed toner image (e.g., the mirror image P) is conveyed facing down from the fixing device B7 to the external output portion B22. The transparent sheet S1 passes the external output portion B22 and enters the sheet adhering apparatus A via the sheet reception opening 1A.

As illustrated in FIG. 2, in the sheet adhering apparatus A, the conveyer 2 receives the transparent sheet S1 and conveys the transparent sheet S1 downward at a constant speed. The reel shaft 31 rotates at a given time according to a control command output by the controller B10 of the image forming apparatus B (depicted in FIG. 1). Accordingly, a peel-stick sheet S3 and a non-transparent sheet S2 adhered to each other is unreeled from a roll set on the support shaft 32. The separation panel 34 peels the non-transparent sheet S2 off the peel-stick sheet S3. The non-transparent sheet S2 obliquely contacts the transparent sheet S1 conveyed by the conveyer 2 at a given speed faster than a conveyance speed V1 at which the transparent sheet S1 is conveyed. Thus, the non-transparent sheet S2 is superimposed on the transparent sheet S1.

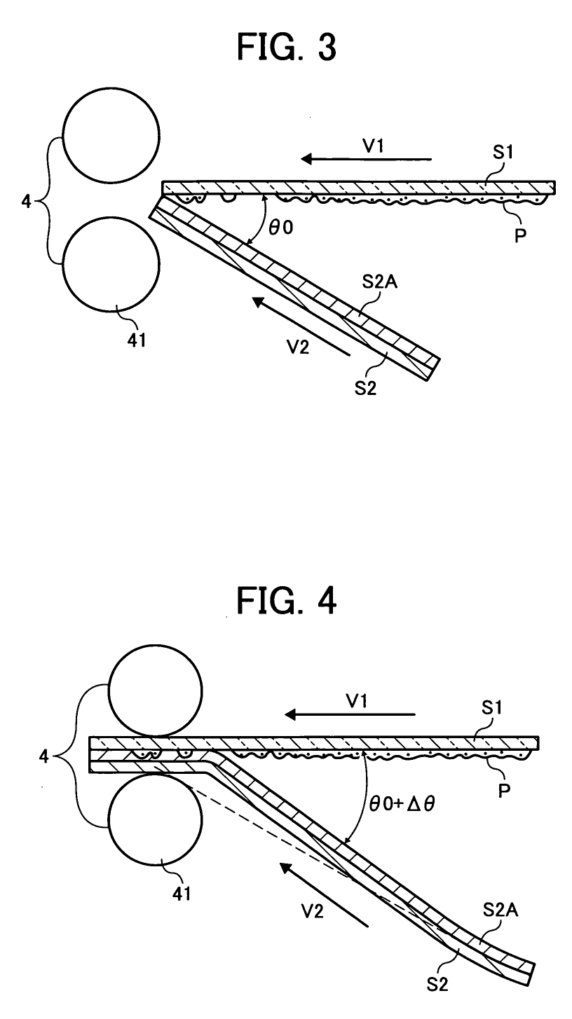

FIG. 3 is a sectional view of the pressing roller pair 4 and the transparent sheet S1 and the non-transparent sheet S2 before contacting the pressing roller pair 4. As illustrated in FIG. 3, the non-transparent sheet S2 includes an adhering layer S2A.

The adhering layer S2A is formed on one side of the non-transparent sheet S2. The adhering layer S2A adheres to a peel-stick layer (not shown) of the peel-stick sheet S3 (depicted in FIG. 2) so as to adhere the non-transparent sheet S2 to the peel-stick sheet S3. When the non-transparent sheet S2 separated from the peel-stick sheet S3 contacts the transparent sheet S1, the adhering layer S2A adheres to the transparent sheet S1.

When a leading edge of the non-transparent sheet S2 contacts a leading edge of the transparent sheet S1, the non-transparent sheet S2 and the transparent sheet S1 form a contact angle θ0. The contact angle θ0 is determined based on a layout of the conveyer 2 and the unreeling device 3 (depicted in FIG. 2). Namely, the leading edge of the non-transparent sheet S2 contacts and adheres to the leading edge of the transparent sheet S1 at the contact angle θ0.

The conveyance speed V2 at which the non-transparent sheet S2 is conveyed is faster than the conveyance speed V1 at which the transparent sheet S1 is conveyed. Therefore, a slight change Δθ is gradually added to the contact angle θ0 as illustrated in FIG. 4. Thus, the non-transparent sheet S2 gradually obtains surplus length with respect to the transparent sheet S1 and is bent and curved. Accordingly, the non-transparent sheet S2 and the transparent sheet S1 are adhered to each other until a trailing edge of the non-transparent sheet S2 is superimposed on a trailing edge of the transparent sheet S1.

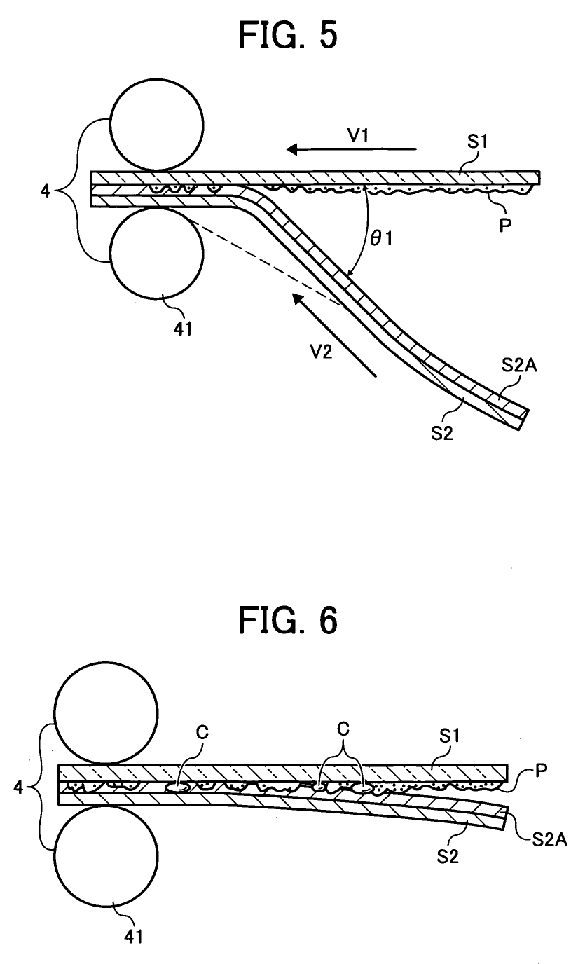

The contact angle θ0 is changed into an adhering angle θ1 as illustrated in FIG. 5. After the non-transparent sheet S2 is adhered to the transparent sheet S1, the pressing roller pair 4 nips the non-transparent sheet S2 and the transparent sheet S1 to adhere the non-transparent sheet S2 to the transparent sheet S1 with an increased force. For example, the pressing roller pair 4 nips the leading edges of the non-transparent sheet S2 and the transparent sheet S1 adhered to each other, and continues nipping the non-transparent sheet S2 and the transparent sheet S1 until the trailing edges of non-transparent sheet S2 and the transparent sheet S1 pass through the pressing roller pair 4.

When the trailing edges of non-transparent sheet S2 and the transparent sheet S1 pass through the third roller pair 23 (depicted in FIG. 2) and adhesion of the non-transparent sheet S2 and the transparent sheet S1 is completed, the unreeling device 3 stops the unreeling operation. The non-transparent sheet S2 and the transparent sheet S1 adhered to each other are output as an image recording sheet onto an internal output tray (not shown) provided in a lower portion of the case 1 (depicted in FIG. 1). When the non-transparent sheet S2 and the transparent sheet S1 adhered to each other are output, the conveyer 2 stops the conveyance operation and waits until a next adhering operation starts. Thus, a series of operations of the sheet adhering apparatus A is completed.

As described above, according to this example embodiment, the non-transparent sheet S2 is conveyed at the conveyance speed V2 faster than the conveyance speed V1 at which the transparent sheet S1 is conveyed. After the non-transparent sheet S2 starts adhering to the transparent sheet S1, the adhering angle θ1 gradually increases until the non-transparent sheet S2 finishes adhering to the transparent sheet S1. The leading edge of the non-transparent sheet S2 contacts the transparent sheet S1 by applying a suppressed impact to the transparent sheet S. Thus, the non-transparent sheet S2 may properly start adhering to the transparent sheet S1. Once the non-transparent sheet S2 starts adhering to the transparent sheet S1, the adhering angle θ1 gradually increases to prevent air bubbles from generating between the non-transparent sheet S2 and the transparent sheet S1 adhering to each other.

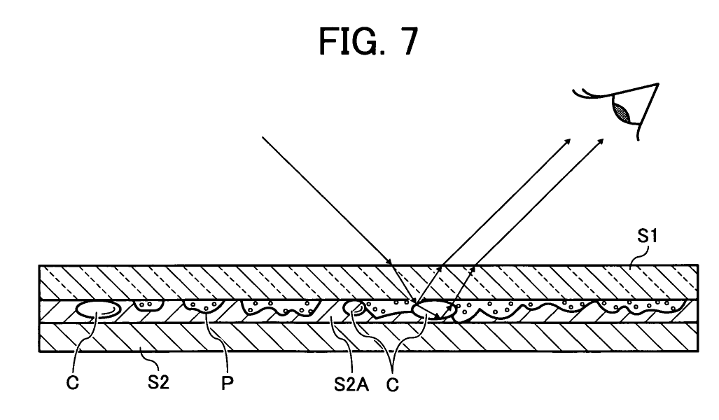

When the adhering angle θ1 is from about 10 degrees to about 45 degrees, for example, the non-transparent sheet S2 may contact the transparent sheet S1 by applying a suppressed impact to the transparent sheet S1. However, air bubbles C may easily generate between the non-transparent sheet S2 and the transparent sheet S1 due to a rough surface of the adhering layer S2A of the non-transparent sheet S2 and/or a slight vibration of the non-transparent sheet S2 and the transparent sheet S1, as illustrated in FIG. 6. When the air bubbles C, even in small amount and/or size, generate between the non-transparent sheet S2 and the transparent sheet S1, the air bubbles C may diffuse light as illustrated in FIG. 7, resulting in an improper image recording sheet.

When the adhering angle θ1 is greater than about 30 degrees and not greater than about 90 degrees, for example, the non-transparent sheet S2 may contact the transparent sheet S1 by applying an increased impact to the transparent sheet S1. However, air bubbles C may not easily generate between the non-transparent sheet S2 and the transparent sheet S1 when the non-transparent sheet S2 has been adhered to the transparent sheet S1. According to this example embodiment, the non-transparent sheet S2 is conveyed at the conveyance speed V2 faster than the conveyance speed V1 at which the transparent sheet S1 is conveyed. Thus, the adhering angle θ1 gradually increases while the non-transparent sheet S2 is being adhered to the transparent sheet S1, preventing air bubbles C from generating between the non-transparent sheet S2 and the transparent sheet S1. As a result, the non-transparent sheet S2 may be properly adhered to the transparent sheet S1.

A difference between the conveyance speeds V1 and V2 is set at an amount in which the adhering angle θ1 does not exceed about 90 degrees immediately before the non-transparent sheet S2 entirely adheres to the transparent sheet S1 (e.g., before adhesion is finished). Therefore, the difference between the conveyance speeds V1 and V2 varies depending on a condition such as a length of the non-transparent sheet S2 and the transparent sheet S1.

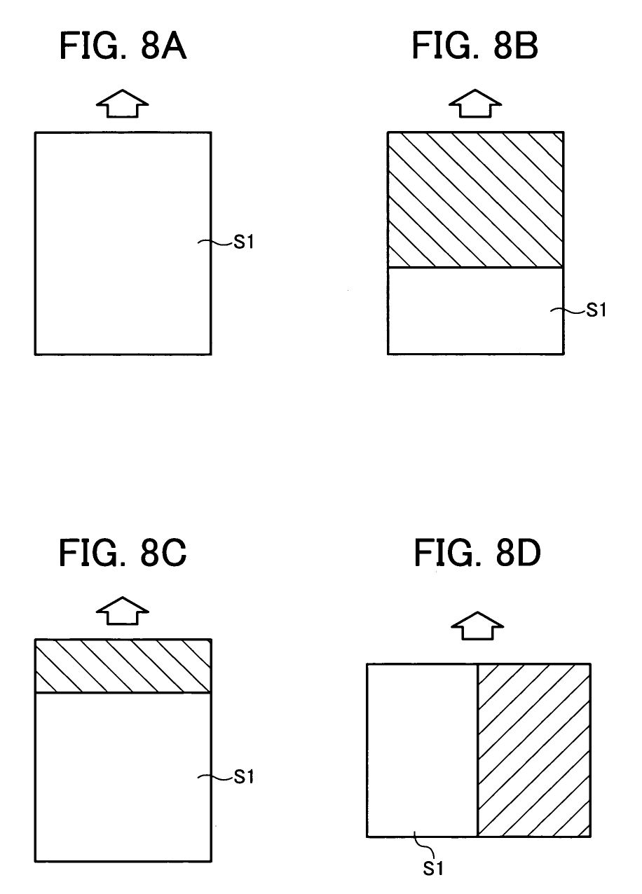

According to this example embodiment, the transparent sheet S1 is entirely transparent as illustrated in FIG. 8A. However, the transparent sheet S1 may be partially non-transparent (e.g., white) as illustrated in FIGS. 8B, 8C, and 8D. In FIGS. 8B, 8C, and 8D, shaded areas are non-transparent and the other areas are transparent.

Referring to FIG. 2, the following describes an example configuration of the sheet adhering apparatus A according to another example embodiment. According to the previous example embodiment, the non-transparent sheet S2 is conveyed at the conveyance speed V2 faster than the conveyance speed V1 of the transparent sheet S1. However, according to this example embodiment, the controller B10 (depicted in FIG. 1) controls the conveyer 2 and the unreeling device 3 so that a non-transparent sheet S2 and a transparent sheet S1 are conveyed at a common speed for a given time period when the non-transparent sheet S2 starts adhering to the transparent sheet S1. After the given time period elapses, the non-transparent sheet S2 is conveyed at the conveyance speed V2 faster than the conveyance speed V1 of the transparent sheet S1 until the non-transparent sheet S2 finishes adhering to the transparent sheet S1. The structure and the other configuration of the sheet adhering apparatus A according to this example embodiment are common to those according to the previous example embodiment. Namely, the conveyance speed V1 of the transparent sheet S1 remains unchanged and the conveyance speed V2 of the non-transparent sheet S2 is changed.

When the leading edge of the non-transparent sheet S2 contacts the transparent sheet S1 at the contact angle θ0, the non-transparent sheet S2 and the transparent sheet S1 are conveyed at the common speed. Thus, the non-transparent sheet S2 may be properly adhered to the transparent sheet S1. After the non-transparent sheet S2 contacts the transparent sheet S1, the conveyance speed V2 of the non-transparent sheet S2 is increased so that the difference between the conveyance speeds V1 and V2 generated in the previous example embodiment is also generated in this example embodiment. For example, the slight change Δθ is gradually added to the contact angle θ0, providing effects common to the effects provided by the previous example embodiment.

A timer (not shown) may count the given time period to increase the conveyance speed V2 of the non-transparent sheet S2. Alternatively, a sensor (not shown) may detect a condition in which the leading edge of the non-transparent sheet S2 contacts (e.g., applies an impact to) the leading edge of the transparent sheet S1. Accordingly, the controller B10 may determine a time to increase the conveyance speed V2 of the non-transparent sheet S2 based on a detection result. However, the time to increase the conveyance speed V2 may be determined in other methods.

Referring to FIG. 2, the following describes an example configuration of the sheet adhering apparatus A according to yet another example embodiment. According to this example embodiment, the controller B10 (depicted in FIG. 1) controls the conveyer 2 and the unreeling device 3 so that a non-transparent sheet S2 and a transparent sheet S1 are conveyed at a common speed for a given time period when the non-transparent sheet S2 starts adhering to the transparent sheet S1. After the given time period elapses, the non-transparent sheet S2 is conveyed at the conveyance speed V2 faster than the conveyance speed V1 of the transparent sheet S1 for another given time period. After the another given time period elapses, the non-transparent sheet S2 and the transparent sheet S1 are conveyed at a common speed until the non-transparent sheet S2 finishes adhering to the transparent sheet S1. The structure and the other configuration of the sheet adhering apparatus A according to this example embodiment are common to those according to the preceding example embodiment shown in FIG. 3. Namely, the conveyance speed V1 of the transparent sheet S1 remains unchanged and the conveyance speed V2 of the non-transparent sheet S2 is changed.

The sheet adhering apparatus A according to this example embodiment may provide effects common to the effects provided by the previous example embodiment. Moreover, the non-transparent sheet S2 and the transparent sheet S1 are conveyed at the common speed, while maintaining the adhering angle θ1, before the non-transparent sheet S2 finishes adhering to the transparent sheet S1. Thus, the non-transparent sheet S2 may be properly adhered to the transparent sheet S1.

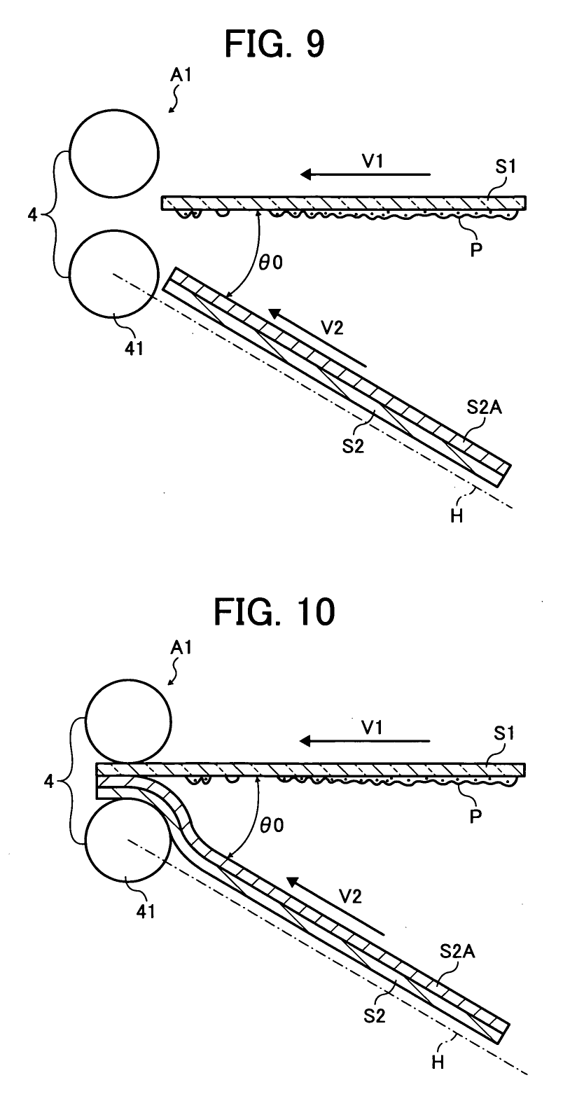

Referring to FIG. 9, the following describes a sheet adhering apparatus A1 according to yet another example embodiment. The unreeling device 3 (depicted in FIG. 2) is disposed at a position at which a leading edge of a non-transparent sheet S2 contacts the pressing roller 41. For example, according to this example embodiment, the unreeling device 3 is disposed closer to the pressing roller pair 4 than in the preceding example embodiment shown in FIG. 3. The other structure and configuration according to this example embodiment are common to the preceding example embodiment shown in FIG. 3.

As illustrated in FIG. 9, the unreeling device 3 (depicted in FIG. 2) unreels the non-transparent sheet S2 toward the pressing roller 41. For example, the unreeling device 3 sends the non-transparent sheet S2 substantially along a normal line H penetrating an axis of the pressing roller 41 toward a position slightly upstream from a nip formed by the pressing roller pair 4 in the sheet conveyance direction.

As illustrated in FIG. 10, the non-transparent sheet S2 unreeled from the unreeling device 3 moves half around an outer circumferential surface of the pressing roller 41. For example, the non-transparent sheet S2 contacts a substantially half portion of the outer circumferential surface of the pressing roller 41 in a rotating direction of the pressing roller 41. The non-transparent sheet S2 contacting the pressing roller 41 is bent around the pressing roller 41 and contacts a transparent sheet S1. Almost simultaneously, the pressing roller pair 4 nips the non-transparent sheet S2 and the transparent sheet S1 to adhere the non-transparent sheet S2 and the transparent sheet S1 to each other. Air bubbles generating between the non-transparent sheet S2 and the transparent sheet S1 may be reduced. The conveyance speed V1 of the transparent sheet S1 and the conveyance speed V2 of the non-transparent sheet S2 may be adjusted as described above in the preceding example embodiments.

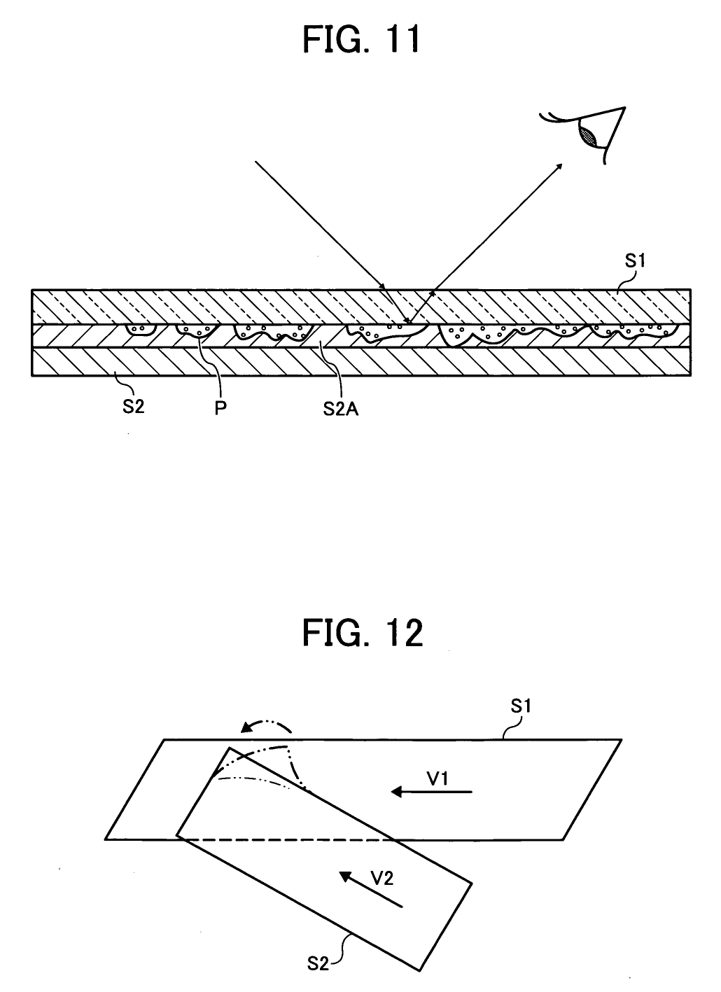

According to the above-described example embodiments, in the sheet adhering apparatus A (depicted in FIG. 2) or A1 (depicted in FIG. 9), a non-transparent sheet S2 and a transparent sheet S1 are adhered to each other to sandwich a mirror image P formed on the transparent sheet S1 by adjusting the conveyance speed V2 of the non-transparent sheet S2 and the conveyance speed V1 of the transparent sheet S1 to be different from each other so as to gradually increase an angle formed by the non-transparent sheet S2 and the transparent sheet S1. Thus, the sheet adhering apparatus A or A1 may provide an image recording sheet bearing a photographic, normal image and not bearing air bubbles which may diffuse light, as illustrated in FIG. 11. When a toner image is formed on the transparent sheet S1 with small, polymerized toner particles, the toner image formed on the transparent sheet S1 may have a uniform height. Accordingly, air bubbles may not easily generate between the transparent sheet S1 and the non-transparent sheet S2. As a result, a high-quality image may be formed in the image recording sheet.

Referring to FIG. 12, the following describes an example configuration of the sheet adhering apparatus A according to yet another example embodiment. According to the preceding example embodiment shown in FIG. 3, the non-transparent sheet S2 is conveyed at the conveyance speed V2 faster than the conveyance speed V1 at which the transparent sheet S1 is conveyed. However, according to this example embodiment, a leading edge of a non-transparent sheet S2 slidably contacts a transparent sheet S1, and the conveyance speed V2 of the non-transparent sheet S2 is slower than the conveyance speed V1 of the transparent sheet S1. The structure and the other configuration of this example embodiment are common to the preceding example embodiment shown in FIG. 3. The conveyance speed V1 of the transparent sheet S1 remains unchanged and the conveyance speed V2 of the non-transparent sheet S2 is changed.

A difference between the conveyance speeds V1 and V2 is provided to cause the leading edge of the non-transparent sheet S2 to slide along the moving transparent sheet S1 for a given time period. As illustrated in FIG. 12, when the leading edge of the non-transparent sheet S2 slides along the moving transparent sheet S1, the transparent sheet S1 applies a tension pulling the non-transparent sheet S2 in the sheet conveyance direction (e.g., the direction in which the transparent sheet S1 is conveyed) to the non-transparent sheet S2. The tension corrects curling of (e.g., straightens) the non-transparent sheet S2. After the non-transparent sheet S2 repeatedly slides along the transparent sheet S1, the non-transparent sheet S2 stops sliding along the transparent sheet S1 and starts adhering to the transparent sheet S1. Thus, the non-transparent sheet S2 may be properly adhered to the transparent sheet S1 constantly. When the non-transparent sheet S2 finishes adhering to the transparent sheet S1 (e.g., when the non-transparent sheet S2 and the transparent sheet S1 are entirely adhered to each other), a high-quality image recording sheet, which is not wrinkled or curled, may be provided.

According to this example embodiment, the conveyance speed V2 of the non-transparent sheet S2 is slower than the conveyance speed V1 of the transparent sheet S1. However, the conveyance speeds V1 and V2 may be adjusted to be different from each other as described above in the preceding example embodiments after the non-transparent sheet S2 stops sliding along the transparent sheet S1 and starts adhering to the transparent sheet S1, so as to reduce air bubbles generated between the non-transparent sheet S2 and the transparent sheet S1.

For example, a given time period for correcting (e.g., eliminating) curling of the non-transparent sheet S2 is set in advance based on evaluations. After the given time period elapses, the conveyance speed V2 of the non-transparent sheet S2 may be adjusted to be faster than the conveyance speed V1 of the transparent sheet S1.

Alternatively, after the given time period for correcting curling of the non-transparent sheet S2 elapses, the conveyance speed V2 of the non-transparent sheet S2 may be adjusted to be equal to the conveyance speed V1 of the transparent sheet S1, and the conveyance speed V2 may be further adjusted to be faster than the conveyance speed V1 until the non-transparent sheet S2 finishes adhering to the transparent sheet S1.

Yet alternatively, after the given time period for correcting curling of the non-transparent sheet S2 elapses, the conveyance speed V2 of the non-transparent sheet S2 may be adjusted to be equal to the conveyance speed V1 of the transparent sheet S1, and the conveyance speed V2 may be further adjusted to be faster than the conveyance speed V1 for another given time period. After the another given time period elapses, the conveyance speed V2 is further adjusted to be equal to the conveyance speed V1 until the non-transparent sheet S2 finishes adhering to the transparent sheet S1. Thus, an adhering angle formed by the non-transparent sheet S2 and the transparent sheet S1 while the non-transparent sheet S2 is adhered to the transparent sheet S1 may be changed.

Yet alternatively, after the given time period for correcting curling of the non-transparent sheet S2 elapses, the conveyance speed V2 of the non-transparent sheet S2 may be increased to be equal to the conveyance speed V1 of the transparent sheet S1.

The non-transparent sheet S2 may be curled due to various reasons. For example, when the non-transparent sheet S2 contacts and adheres to the transparent sheet S1, airflow generated by the non-transparent sheet S2 and the transparent sheet S1, which are conveyed, an/or vibration generated by a driving motor (not shown) may curl the non-transparent sheet S2. Variations in a position at which the non-transparent sheet S2 starts peeling off a peel-stick sheet S3 (depicted in FIG. 2) may also curl the non-transparent sheet S2.

The structure and configuration of the sheet adhering apparatus A (depicted in FIG. 2) or A1 (depicted in FIG. 9) are not limited to the above-described example embodiments. For example, variations and modifications of the above-described sheet adhering apparatus A or A1 are possible.

For example, according to the above-described example embodiments, the conveyance speed V1 of the transparent sheet S1 remains unchanged and the conveyance speed V2 of the non-transparent sheet S2 is adjusted to provide a difference between the conveyance speeds V1 and V2. However, the conveyance speed V2 of the non-transparent sheet S2 may remain unchanged and the conveyance speed V1 of the transparent sheet S1 may be adjusted to provide a difference between the conveyance speeds V1 and V2.

According to the above-described example embodiments, a mirror image P is formed on a transparent sheet S1, and a non-transparent sheet S2 (e.g., a white sheet) is adhered to the transparent sheet S1. However, a mirror image P may be formed on a non-transparent sheet S2, and the non-transparent sheet S2 may be adhered to a transparent sheet S1.

According to the above-described example embodiments, the sheet adhering apparatus A (depicted in FIG. 2) or A1 (depicted in FIG. 9) is connected to the image forming apparatus B (depicted in FIG. 1) so as to output an image recording sheet. However, the above-described example embodiments may be applied not only to an apparatus or a device for outputting an image recoding sheet but also to any apparatus or device for adhering sheets to each other.

The above-described example embodiments are explained by applying to the sheet adhering apparatus A or A1. However, the above-described example embodiments may be applied to a method for adhering first and second sheets (e.g., a transparent sheet S1 and a non-transparent sheet S2) by providing a difference between conveyance speeds of the first and second sheets so as to change an angle at which the first and second sheets are adhered to each other. In this case, the method may preferably provide the difference between the conveyance speeds of the first and second sheets as described above.

As illustrated in FIG. 9, a second sheet (e.g., a non-transparent sheet S2) may be unreeled in a manner that a leading edge of the second sheet contacts the pressing roller 41 provided closer to the second sheet than a first sheet (e.g., a transparent sheet S1). The first and second sheets are adhered to each other in a state in which the first and second sheets sandwich a mirror image P so as to provide an image recording sheet. In this case, the mirror image P may be formed on the transparent sheet S1 with small, polymerized toner particles. For example, the white non-transparent sheet S2 and the transparent sheet S1 may be adhered to each other.

As illustrated in FIG. 2, a first sheet (e.g., a transparent sheet S1) and a second sheet (e.g., a non-transparent sheet S2) are conveyed to obliquely contact each other at a contact position. At the contact position, the first and second sheets contact and start adhering to each other while the first and second sheets are conveyed at different conveyance speeds, respectively. For example, the second sheet is unreeled toward the first sheet in a direction oblique to a direction in which the first sheet is conveyed, so that the second sheet adheres to the first sheet. The second sheet is conveyed toward the first sheet at a conveyance speed faster than a conveyance speed of the first sheet. After leading edges of the first and second sheets are adhered to each other, the second sheet conveyed at the faster speed gradually obtains surplus length with respect to the first sheet and starts bending. Accordingly, an adhering angle formed by the first and second sheets contacting and adhering to each other becomes greater gradually after the second sheet starts adhering to the first sheet. Thus, the second sheet may start adhering to the first sheet while applying a suppressed impact to the first sheet when the leading edge of the second sheet contacts the first sheet. Once the second sheet starts adhering to the first sheet, the adhering angle formed by the first and second sheets increases gradually, preventing air bubbles from generating between the first and second sheets adhered to each other.

Alternatively, the first and second sheets are conveyed at different conveyance speeds so that the leading edge of the second sheet slides along the moving first sheet for a given time period. When the leading edge of the second sheet slides along the moving first sheet, the first sheet applies a tension pulling the second sheet in the direction in which the first sheet is conveyed to the second sheet. The tension straightens the second sheet and the second sheet starts adhering to the first sheet. Thus, the second sheet may properly adhere to the first sheet constantly. As a result, the first and second sheets adhered to each other may form a high-quality image recording sheet which is not curled or wrinkled.

When an image forming apparatus (e.g., the image forming apparatus B depicted in FIG. 1) forms a toner image with small, polymerized toner particles in an electrophotographic method, the first and second sheets may adhere to each other in a state in which the first and second sheets sandwich the toner image so as to form an image recording sheet. The image recording sheet may not include air bubbles and may not be curled or wrinkled, providing a high-quality, photographic image.

The present invention has been described above with reference to specific example embodiments. Nonetheless, the present invention is not limited to the details of example embodiments described above, but various modifications and improvements are possible without departing from the spirit and scope of the present invention. It is therefore to be understood that within the scope of the associated claims, the present invention may be practiced otherwise than as specifically described herein. For example, elements and/or features of different illustrative example embodiments may be combined with each other and/or substituted for each other within the scope of the present invention.

What is claimed is:

1. A sheet adhering apparatus, comprising:
an adhering device to convey a first sheet at a first conveyance speed and a second sheet at a second conveyance speed different from the first conveyance speed,
the adhering device causing the second sheet to obliquely contact and adhere to the first sheet at a given adhering angle.

2. The sheet adhering apparatus according to claim 1,
wherein the adhering device comprises:
a conveyer to convey the first sheet in a first sheet conveyance direction; and
an unreeling device to unreel and convey the second sheet in a direction oblique to the first sheet conveyance direction to cause the second sheet to contact and adhere to the first sheet conveyed by the conveyer.

3. The sheet adhering apparatus according to claim 1,
wherein one of the first conveyance speed of the first sheet and the second conveyance speed of the second sheet remains unchanged and another one of the first and second conveyance speeds is adjusted to cause the first and second conveyance speeds to be different from each other.

4. The sheet adhering apparatus according to claim 1,
wherein one of the first and second sheets is transparent and another one of the first and second sheets is non-transparent, and
wherein the first and second sheets sandwich an image formed on one of the first and second sheets and adhere to each other.

5. The sheet adhering apparatus according to claim 4,
wherein the first sheet is transparent and bears the image and the second sheet is non-transparent and comprises an adhering layer formed on one side of the second sheet and adhered to the first sheet.

6. The sheet adhering apparatus according to claim 4,
wherein the image is formed with small, polymerized toner particles.

7. The sheet adhering apparatus according to claim 2, further comprising:
a pressing portion to receive and press the first and second sheets, the pressing portion comprising a pressing roller to rotate and engage with the second sheet.

8. The sheet adhering apparatus according to claim 7,
wherein the unreeling device causes a leading edge of the second sheet conveyed in the direction oblique to the first sheet conveyance direction of the first sheet to contact the pressing roller, and the pressing roller bends the second sheet toward the first sheet.

9. The sheet adhering apparatus according to claim 2,
wherein the unreeling device conveys the second sheet at the second conveyance speed faster than the first conveyance speed of the first sheet to change the given adhering angle.

10. The sheet adhering apparatus according to claim 2,
wherein the unreeling device conveys the second sheet at the second conveyance speed equal to the first conveyance speed of the first sheet for a given time period when the second sheet starts adhering to the first sheet, and
wherein, after the given time period elapses, the unreeling device conveys the second sheet at the second conveyance speed faster than the first conveyance speed of the first sheet until the second sheet finishes adhering to the first sheet, so as to change the given adhering angle.

11. The sheet adhering apparatus according to claim 2,
wherein the unreeling device conveys the second sheet at the second conveyance speed equal to the first conveyance speed of the first sheet for a first given time period when the second sheet starts adhering to the first sheet,
wherein, after the first given time period elapses, the unreeling device conveys the second sheet at the second conveyance speed faster than the first conveyance speed of the first sheet for a second given time period, and
wherein, after the second given time period elapses, the unreeling device conveys the second sheet at the second conveyance speed equal to the first conveyance speed of the first sheet until the second sheet finishes adhering to the first sheet, changing the given adhering angle.

12. The sheet adhering apparatus according to claim 2,
wherein the unreeling device corrects curling of the second sheet by conveying the second sheet at the second conveyance speed lower than the first conveyance speed of the first sheet to cause a leading edge of the second sheet to slide along the first sheet.

13. The sheet adhering apparatus according to claim 12,
wherein, after curling of the second sheet is corrected, the unreeling device conveys the second sheet at the second conveyance speed faster than the first conveyance speed of the first sheet, changing the given adhering angle.

14. The sheet adhering apparatus according to claim 12,
wherein, after curling of the second sheet is corrected, the unreeling device conveys the second sheet at the second conveyance speed equal to the first conveyance speed of the first sheet, changing the given adhering angle.

15. The sheet adhering apparatus according to claim 12,
wherein, after curling of the second sheet is corrected, the unreeling device conveys the second sheet at the second conveyance speed equal to the first conveyance speed of the first sheet for a given time period, and
wherein, after the given time period elapses, the unreeling device conveys the second sheet at the second conveyance speed faster than the first conveyance speed of the first sheet until the second sheet finishes adhering to the first sheet, changing the given adhering angle.

16. The sheet adhering apparatus according to claim 12,
wherein, after curling of the second sheet is corrected, the unreeling device conveys the second sheet at the second conveyance speed equal to the first conveyance speed of the first sheet for a first given time period,
wherein, after the first given time period elapses, the unreeling device conveys the second sheet at the second conveyance speed faster than the first conveyance speed of the first sheet for a second given time period, and
wherein, after the second given time period elapses, the unreeling device conveys the second sheet at the second conveyance speed equal to the first conveyance speed of the first sheet until the second sheet finishes adhering to the first sheet, changing the given adhering angle.

17. A sheet adhering method, comprising:
conveying a first sheet at a first conveyance speed in a first sheet conveyance direction;
conveying a second sheet at a second conveyance speed in a direction oblique to the first sheet conveyance direction different from the first conveyance speed; and
contacting the second sheet against the first sheet at a given adhering angle.

18. The sheet adhering method according to claim 17,
wherein the second conveyance speed of the second sheet is faster than the first conveyance speed of the first sheet to change the given adhering angle.

19. The sheet adhering method according to claim 17,
wherein the second conveyance speed of the second sheet is slower than the first conveyance speed of the first sheet to cause a leading edge of the second sheet to slide along the first sheet until curling of the second sheet is corrected.
